(19) United States
(12) Patent Application Publication
(10) Pub. No.: US 2025/0103993 A1
(43) Pub. Date: Mar. 27, 2025

(54) METHOD AND SYSTEM FOR CALCULATING GLOBAL SUSTAINABILITY SCORE OF AN ENTITY IN REAL-TIME

(71) Applicant: LTI Mindtree Ltd, Mumbai (IN)

(72) Inventors: SIVAPREETA JAYACHANDRAN, Mumbai (IN); SUPARNA DUTTA, Mumbai (IN)

(73) Assignee: LTI Mindtree Ltd, Mumbai (IN)

(21) Appl. No.: 18/610,843

(22) Filed: Mar. 20, 2024

(30) Foreign Application Priority Data
Sep. 26, 2023 (IN) 202321064636

(51) Int. Cl. G06Q 10/0637; G06Q 10/0639

(52) U.S. Cl. CPC G06Q 10/06375; G06Q 10/06393

(57) ABSTRACT

The invention provides a smart building model (104) for calculating real-time global sustainability score and forecasting global sustainability score of an entity (102) with buildings at multiple geographical locations. The smart building model (104) comprises a data acquisition module (214) that acquires data from a plurality of sensors that monitor data of assets associated with each building. A key performance indicator (KPI) module (216) assess KPIs based on data acquired from the sensors. Sustainability score of each building is evaluated by a sustainability score evaluation module (218) that compares KPIs of the assets against a selected compliance standard. A global sustainability score of the entity (102) is estimated by aggregating sustainability scores of each building and assessing weights assigned to the KPIs by an aggregation module (220). A reporting module (222) displays a report with global sustainability score of the entity (102) along with sustainability scores of each building.

### FIELD OF THE INVENTION

Various embodiments of the invention generally relate to calculating and forecasting sustainability score. More particularly, the invention relates to calculating, based on multiple parameters, live global sustainability score and forecasting short term and long-term sustainability scores of an entity having one or more buildings in one or more geographical locations and displaying a report indicating the sustainability score of each building and the global sustainability score of the entity and recommending optimization measures.

### BACKGROUND OF THE INVENTION

Numerous building management solutions exist in the current market landscape. However, there remains a distinct and unaddressed requirement for a unified approach to incorporate the sustainable elements of Environmental, Social, and Governance (ESG) reporting and control. This need arises from several key challenges, including the segmented operational management of individual building assets, the absence of a transparent and consolidated central system or framework for obtaining crucial business insights and optimizing efficiency, as well as the integration of sustainability metrics. Additionally, the absence of standardized Key Performance Indicators (KPIs) encompassing areas such as sustainability, building efficiency, and asset performance further compounds the existing gaps.

Furthermore, the current solutions fall short in effectively addressing the challenges related to enhancing efficiency and optimizing systems through interoperable data. For instance, the task of optimizing chiller efficiency based on occupancy patterns and analytics remains largely unattended. Additionally, the need to unify value chains and bring multiple agencies together under a single program, encompassing tasks ranging from device onboarding and system integrations to third-party integrations, dashboards, and operations and maintenance, poses a considerable challenge in establishing a comprehensive sustainability platform.

These existing solutions also exhibit deficiencies in offering end-to-end solutions and keeping up with advancements in edge computing, analytics, reporting, and dashboard capabilities. There's a noticeable absence of a model to establish specific sustainability goals tailored to organizations and facilities. Furthermore, the absence of standardized criteria and formulas for quantifying sustainability scores further compounds the limitations.

Significantly, a substantial gap in data governance hinders effective management of strategic organizational visions and objectives, such as ESG goals, Net Zero aspirations, and operational decarbonization.

In addition, the current solutions concerning the assessment of sustainability scores lack a centralized system capable of standardizing multivariate sustainability parameters extracted from a building into a cohesive sustainability scoring method. Moreover, these existing solutions do not effectively tackle the complexities tied to monitoring, tracking, predicting, recommending and controlling the aggregated insights of sustainability metrics across multiple facilities spanning geographical locations. This deficiency pertains to evaluating these metrics against both global sustainability benchmarks and the specific sustainability goals of organizations.

Therefore, there exists a need for a method and system that can address the aforementioned challenges using a centralized system that calculates a real-time global sustainability score and forecasts global sustainability score of an entity having one or more buildings in one or more geographical locations.

### SUMMARY OF THE INVENTION

The invention discloses a method and system for calculating global sustainability score of an entity having at least one building in at least one geographical location. The method and system includes a smart building model, which comprises a data acquisition module that acquires data in real-time from a plurality of sensors and external sources that monitor data pertaining to one or more assets associated with each building of the entity and static data from manual logs. A key performance indicator (KPI) module assess KPIs pertaining to the assets based on the data acquired from the sensors. The sustainability score of each building is then evaluated by a sustainability score evaluation module by comparing KPIs of the assets against a selected compliance standard.

A global sustainability score of the entity is then estimated in real-time by aggregating sustainability scores of each building and based on weights assigned to the KPIs of the assets of each building. Additionally, the method and system forecasts the sustainability score by utilizing one or more ML models that are trained on data such as, but not limited to, sustainability score pattern, historical trends of energy consumption and savings, water consumption and savings, emissions, waste generation and recycled, indoor environment quality, building design, and operational efficiency. Alternatively, the global sustainability score is a weighted average across its connected buildings based on their size, location, occupancy strength, etc. A reporting module generates a report and displays the global sustainability score of the entity along with the sustainability score of each building to users.

One or more advantages of the prior art are overcome, and additional advantages are provided through the invention. Additional features are realized through the technique of the invention. Other embodiments and aspects of the disclosure are described in detail herein and are considered a part of the invention.

### BRIEF DESCRIPTION OF THE FIGURES

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the invention.

FIG. 1 is a diagram that illustrates an environment in which various embodiments of the invention may function.

FIG. 2 illustrates a system for calculating the global sustainability score of an entity in accordance with an embodiment of the invention.

FIG. 3 is a flow chart illustrating a method for calculating the global sustainability score of an entity in accordance with an embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

Before describing in detail embodiments that are in accordance with the present invention, it should be observed that the embodiments reside primarily in combination of method steps and components related to a method and system for calculating the global sustainability score of an entity. Accordingly, the system components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

Systems for calculating a global sustainability score of an entity, methods for calculating global sustainability score of an entity are disclosed herein. The systems, methods, and non-transitory computer readable media disclosed herein calculates the global sustainability score of an entity and display a report indicating the global sustainability score of the entity. It is important to note that the global sustainability score calculated in the present invention does not mean directly assessing the sustainability score of the entity. Instead, the goal is to assess the sustainability score of each building located at different geographical locations, related to the entity and aggregate the sustainability score of each building to estimate the global sustainability score.

In one general aspects of this disclosure, a system of one or more computer executable software and data, computer machines and components thereof, networks, and/or network equipment can be configured to perform particular operations or action individually, collectively, or in a distributed manner to case the system of components thereof to perform calculation of global sustainability score of an entity having at least one building in at least one geographical location and display a report indicating the sustainability score of each building and the global sustainability score of the entity.

Sustainability refers to using natural resources in a way that allows the same amount of resource to be produced over time. In addition, it also refers to anything from environmental factors, financial performance, and social impact.

A sustainability score, often referred to as a sustainability rating, represents a metric assessing an entity's performance in terms of environmental responsibility, social impact, and governance standards (ESG). Entities are evaluated by score providers across a spectrum of criteria, including but not limited to aspects like natural resources and energy usage, climate change, human rights, employee relationships, supply chain oversight, and community involvement. The purpose of a sustainability score is to aid entities in enhancing their performance by identifying areas that require refinement, predict possible lag or failures, and provide recommendation measures to optimize the operations.

ESG encapsulates an evaluation that takes into account the holistic assessment of environmental, social, and governance aspects. Within this framework, environmental considerations gauge an entity's and an industry's impact on ecological concerns, potentially encompassing issues like waste management, pollution control, responsible resource utilization, greenhouse gas emissions, deforestation, and the repercussions of climate change. Social considerations delve into how a company treats individuals, concentrating on matters such as employee relationships, diversity, working conditions, interactions with local communities, health and safety, and conflict resolution. Governance considerations center around corporate policies and the manner in which a company is administratively governed. This facet may encompass aspects such as tax strategies, executive compensation, philanthropic contributions, involvement in political activities, the handling of corruption and bribery concerns, diversity initiatives, and overall corporate structure.

The computation of an entity's sustainability score depends on one or more sustainability factors, which encompass a variety of considerations. These factors may include, among others, measurements related to energy consumption or efficiency, water utilization, resource management, emissions, energy sourcing, raw materials, carbon footprint, waste handling, waste effluent, occupational safety, corporate policies, regulatory compliance, building performance indices (BPI), energy efficiency indices (EEI), energy conservation, renewable energy adoption—both onsite and offsite, water balance encompassing consumption and recycling, initiatives for reducing, reusing, and recycling, air and water quality, emission and effluent control, and an organization's Corporate Social Responsibility (CSR) efforts, such as tree planting initiatives and corresponding carbon sequestration.

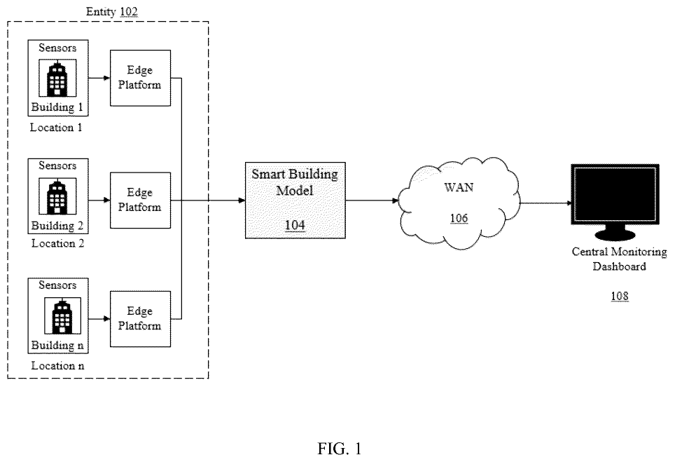

FIG. 1 is a diagram that illustrates an environment 100 in which various embodiments of the invention can be implemented. Referring to FIG. 1, the environment 100 comprises an entity 102, a smart building model 104, a Wide Area Network (WAN) 106, and a central monitoring platform 108.

The entity 102 pertains to a plurality of categories, which may include but are not limited to commercial categories (e.g., offices, institutions, healthcare facilities), industrial categories (e.g., shop floors, factories, warehouses), residential categories, and retail-mixed developments categories. Within the context of the entity 102, there exist one or more buildings situated across diverse geographical locations, such as the instances denoted as location 1, location 2, and location N. The geographical locations themselves can be geographically distinct, encompassing different zones, distinct boundaries, separate cities, various states, and even different countries.

In an exemplary embodiment, each building of the one or more buildings may represent an entire facility. Alternatively, certain scenarios might involve each building representing a subsection of a larger facility, such as a floor within a substantial establishment or another distinct section within such premises. It's also possible for a building to stand for a campus, comprising multiple separate buildings strategically situated within a geographic expanse. Business campuses, characterized by a multitude of distinct buildings jointly managed and operated, offer a suitable example. Similarly, the context of college campuses underscores another instance wherein diverse buildings are collectively overseen and utilized.

Each building of the one or more buildings of the entity 102 includes a plurality of building assets that are individually configured. Referring to FIG. 1, each building of the one or more buildings of the entity 102 is merely illustrative, the actual number and variations within these buildings are substantially greater.

Each building located at respective locations is equipped with a plurality of assets. The plurality of assets can be such as, but not limited to, waste treatment plants, Uninterrupted Power Supply (UPS) units, generators, security systems, transformers, air conditioning units, water resources, chiller systems, emission management systems, rooftop solar setups, Heating, Ventilation, and Air Conditioning (HVAC) mechanisms, air handlers, water treatment facilities, intelligent waste bins, fire hydrant systems, fire alarms, and exhaust systems.

The plurality of assets are associated with one or more sensors that constantly collect data. The plurality of sensors associated with the assets can be such as, but not limited to, timing sensors, location sensors, biometric sensors, environmental parameter sensors, humidity sensors, device state sensors, temperature sensors, Relative Humidity (RH) sensors, pressure sensors, flow sensors, power sensors, occupancy sensors, Carbon Dioxide (CO2) sensors, and indoor and outdoor Air Quality (IAQ) sensors.

In an embodiment, each building of the one or more buildings distributed across one or more geographical locations is connected to an edge platform. The edge platform is configured to integrate with the one or more sensors associated with the plurality of the assets. The main function of the platform is to analyze and process the data received from the sensors in real-time. The edge platform disclosed in the present invention may include a plurality of edge devices with common functions such as transmission, routing, monitoring, filtering, translation, and storage of data passing between networks. Furthermore, the edge platform with edge computing can facilitate routing of the building data and/or enrichment of the building data based on a digital twin of a building managed by a digital twin manager. The digital twin concept aids in creating a dynamic and comprehensive representation of the building, further enriching the data processing capabilities of the edge platform.

Employment of the edge computing effectively moves some portion of storage and computing resources out of the central data center and closer to the source of the data itself. Rather than transmitting raw data to a central data center for processing and analysis, that work is instead performed where the data is actually generated whether that is an enterprise data, industrial data, a retail store data, factory floor data, a sprawling utility or data across a smart city. Only the result of that computing work at the edge, such as real-time business insights, equipment maintenance predictions or other actionable answers, is sent back to the main data center for review and other human interactions.

In an embodiment the smart building model 104 disclosed in the present invention standardizes multi-variate sustainability parameters from one or more buildings of the entity 102 with a unified sustainability score. The smart building model 104 monitors, tracks, controls combined intelligence of sustainability metrics of multiple facilities across geography. The intelligence is then compared against both global benchmarks and the predefined sustainability objectives set by the entity 102.

The smart building model 104 connects, measures, monitors and optimizes all assets, their performance under each building of the one or more buildings. This comprehensive coverage is extended to encompass the entirety of the entity 102 portfolio. The monitored data is fused across all the assets, processes, events, and personnel. This fused data is subjected to combined intelligence operations that facilitate the optimization of the complete value chain. Once integrated, this data is employed to monitor energy performance, sustainability endeavors, and progress of the entity 102 towards climate change objectives. The utilization of Artificial Intelligence (AI) models further enhances these capabilities. Through the application of AI models, the smart building model 104 generates potent insights, recommendations, and real-time corrective actions to augment operational efficiency.

In an exemplary embodiment, the smart building model 104 effectively receives both static and real-time data inputs from each building.

Static data from a building encompasses a range of information, including but not confined to integrated design details, building-related regulations and approvals, infrastructure for rainwater harvesting, energy policies, targeted savings objectives, emission reduction targets, a master plan for waste segregation, as well as essential mandatory requirements.

On the other hand, real-time data received from a building is comprised of dynamic and immediate information. Examples of this real-time data comprise site preservation efforts, compliance with green building guidelines, the proportion of rainwater successfully harvested, energy efficiency metrics, consumption levels, emissions categorized as scope 1, 2, and 3, data on water management, the Air Quality Index (AQI), and pollution levels.

In an embodiment, the smart building model 104 communicates with the central monitoring platform 108 via the WAN 106. This communication facilitates the presentation of comprehensive reports containing the global sustainability score of the building. Alongside this score, the report also offers vital insights, recommendations, and necessary actions to enhance sustainability.

The WAN 104 of the environment 100 is any wide area network (for example, the internet) capable of communicating computer data over non-local distances by any technology for communicating computer data, now known or to be developed in the future. In some embodiments, the WAN 104 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

In some embodiments, the WAN 104 of the environment 100 may utilize clustered computing and components acting as a single pool of seamless resources when accessed through the WAN 104 by one or more computing systems. For example, such embodiments can be used in a data center, cloud computing network, storage area network (SAN), and network-attached storage (NAS) applications.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service.

A cloud computing environment is service-oriented, focusing on statelessness, low coupling, modularity, and semantic interoperability. At the heart of cloud computing is an infrastructure that includes a network of interconnected nodes.

In some non-limiting embodiments, the cloud computing environment includes a cloud network comprising one or more cloud computing nodes with which cloud consumers may use the end-user device(s) or client devices to access one or more software products, services, applications, and/or workloads provided by cloud service providers or tenants of the cloud network. Examples of the user device are depicted and may include devices such as a desktop computer, laptop computer, smartphone, or cellular telephone, tablet computers, and smart devices such as a smartwatch or smart glasses. Nodes may communicate with one another and may be grouped (not shown) physically or virtually in one or more networks, such as Private, Community, Public, or Hybrid clouds as described hereinabove, or a combination thereof. This allows the cloud computing environment to offer infrastructure, platforms, and/or software as services for which a cloud consumer does not need to maintain resources on a local computing device.

Public Cloud is any computer system available for use by multiple entities that provides on-demand availability of computer system resources and/or other computer capabilities, especially data storage (cloud storage) and computing power, without direct active management by the user.

Private Cloud is similar to the public cloud, except that the computing resources are only available for use by a single enterprise. While the private cloud is depicted as being in communication with WAN, in other embodiments, a private cloud may be disconnected from the internet entirely and only accessible through a local/private network.

A hybrid cloud is composed of multiple clouds of different types (for example, private, community, or public cloud types), often implemented by different vendors. Each of the multiple clouds remains a separate and discrete entity. Still, the larger hybrid cloud architecture is bound together by standardized or proprietary technology that enables orchestration, management, and/or data/application portability between the multiple constituent clouds.

The central monitoring dashboard 108 refers to a centralized display interface system that offers a comprehensive overview including both the global sustainability score of the entity 102 and the regional sustainability scores associated with one or more buildings situated across various geographical locations.

In an exemplary embodiment, the central monitoring dashboard 108 is configured to display one or more data analysis reports. These reports may include the global sustainability score of the entity 102, the regional sustainability score of a specific building, Key Performance Indicators (KPIs), values associated with resource consumption, and similar metrics.

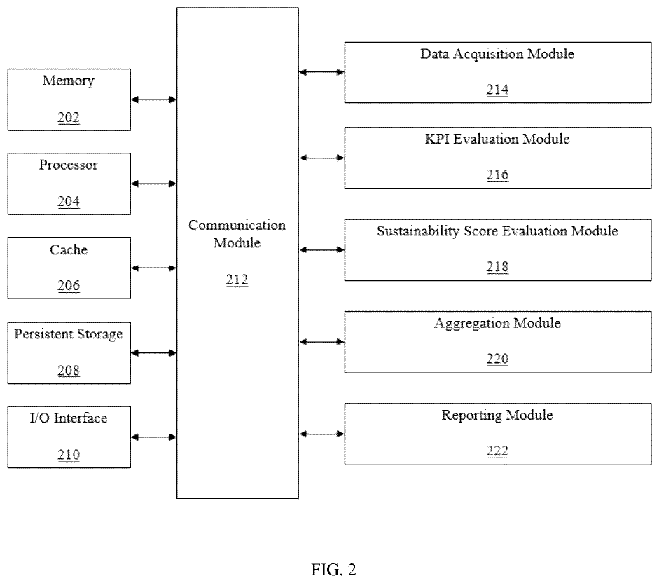

FIG. 2 illustrates a system 200 diagram of the smart building model 104 for calculating global sustainability score of the entity 102 in accordance with an embodiment of the invention. Referring to FIG. 2, the system 200 includes a memory 202, a processor 204, a cache 206, a persistent storage 208, a I/O interface 208, a communication module 212, a data acquisition module 214, a KPI evaluation module 216, a sustainability score evaluation module 218, an aggregation module 220, a reporting module 222, an audit generation module 224, and a forecast module 226

The memory 202 may comprise suitable logic and/or interfaces that may be configured to store instructions (for example, the computer-readable program code) that can implement various aspects of the present invention. In an embodiment, the memory 202 includes random access memory (RAM). In general, the memory 202 can include any suitable volatile or non-volatile computer-readable storage media.

The processor 204 may comprise suitable logic, interfaces, and/or code that may be configured to execute the instructions stored in the memory 202 to implement various functionalities of the system 200 in accordance with various aspects of the present invention. The processor 204 may be further configured to communicate with multiple modules of the system 200 via the communication module 212.

The cache 206 is a memory that is typically used for data or code that should be available for rapid access by the threads or cores running on the processor 204. Cache memories are usually organized into multiple levels depending upon relative proximity to the processing circuitry. Alternatively, some, or all, of the cache for the processor set may be located “off-chip”.

Computer readable program instructions are typically loaded onto the system 200 to cause a series of operational steps to be performed by the processor 204 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as the cache 206 and the other storage media discussed below. The program instructions, and associated data, are accessed by the processor 204 to control and direct the performance of the inventive methods.

The persistent storage 208, is any form of non-volatile storage for computers that is now known or to be developed in the future. The non-volatility of this storage means that the stored data is maintained regardless of whether power is being supplied to the system 200 and/or directly to the persistent storage 208. The persistent storage 208 may be a read only memory (ROM). Still, typically at least a portion of the persistent storage allows writing of data, deletion of data, and re-writing of data. Some familiar forms of persistent storage include magnetic disks and solid-state storage devices. The media used by persistent storage 208 may also be removable. For example, a removable hard drive may be used for persistent storage 208. Other examples include optical and magnetic disks, thumb drives, and smart cards inserted into a drive for transfer onto another computer-readable storage medium that is also part of persistent storage 208.

The I/O interface 210 allows input and output of data with other devices that may be connected to each computer system. For example, the I/O interface(s) 210 may provide a connection to an external device(s) such as a keyboard, a keypad, a touch screen, and/or some other suitable input device. External device(s) can also include portable computer-readable storage media, such as, for example, thumb drives, portable optical or magnetic disks, and memory cards. Program instructions and data (e.g., software and data) used to practice embodiments of the present invention can be stored on such portable computer-readable storage media and loaded onto the persistent storage 208 via the I/O interface(s) 210.

The data acquisition module 214 acquires data in real-time from the plurality of sensors that are configured to constantly monitor data pertaining to one or more assets associated with each building of the at least one building in at least one geographical location.

In some non-limiting embodiments, the data acquisition module 214 may also acquire data from any form of external sources apart from the plurality of sensors. These sources could encompass a broad spectrum, ranging from data linked to regulatory policies and governmental mandates to weather-related data, manual logs and other relevant applications.

The one or more assets associated with each building can be such as, but not limited to, waste treatment plants, Uninterrupted Power Supply (UPS), generators, security systems, transformers, air conditioners, water resources, chiller systems, emission systems, roof top solar systems, Heating, ventilation, and Air Conditioning (HVAC), air handlers, water treatment plant, smart bins, fire hydrant systems, fire alarm, and exhaust systems.

The plurality of assets are associated with one or more sensors that continuously collect data. The plurality of sensors associated with the assets can be such as, but not limited to, timing sensors, location sensors, biometric sensors, environmental variable sensors, humidity sensors, device state sensors, temperature sensors, RH sensors, pressure sensors, flow sensors, power sensors, occupancy sensors, CO2 sensors, and indoor and outdoor Air Quality (IAQ) sensors.

The KPI evaluation module 216 is configured to assess KPIs pertaining to the one or more assets based on the data acquired from the plurality of sensors and the one or more external sources.

In some non-limiting embodiments, the KPIs comprise a diverse array of indicators. Examples include, but are not limited to, a waste water plant performance indicator, UPS performance indicator, generator performance indicator, security system performance indicator, transformer performance indicator, air conditioner performance indicator, water resource performance indicator, chiller system performance indicator, emission system performance indicator, solar system performance indicator, heating system performance indicator, ventilation performance indicator, HVAC performance indicator, air handler performance indicator, water treatment plant performance indicator, smart bins performance indicator, fire hydrant system performance indicator, and exhaust system performance indicator.

The sustainability score evaluation module 218 is configured to evaluate a sustainability score of each building. The sustainability score evaluation module 218 is configured to compare KPIs pertaining to the one or more assets against a selected compliance standard.

In an embodiment, the compliance standard can be chosen from a selection that includes entities like IGBC (Indian Green Building Council), ECBC (Energy Conservation Building Code under Bureau of Energy Efficiency), USGBC (United States Green Building Council), BREAM (Building Research Establishment Environmental Assessment Methodology), SGBC (Singapore Green Building Council), and BRSR (Business Responsibility and Sustainability Reporting).

The aggregation module 220 is configured to aggregate the sustainability scores corresponding to each building. Through this aggregation, an estimate for the global sustainability score can be derived. The global sustainability score is estimated in real-time based on one or more weights assigned to the KPIs pertaining to the one or more assets of each building.

The sustainability scores corresponding to each building are aggregated using one or more data aggregation algorithms. The data aggregation algorithms, when employed, derives values of KPIs of each asset of the plurality of assets and calculates the value of aggregate KPI using a weighted average of values for the plurality of KPIs associated with the plurality of assets.

In an embodiment the one or more weights are assigned to the KPIs pertaining to the one or more assets of each building on the basis of several factors. These factors encompass building design efficiency, site planning, water conservation measures, energy efficiency initiatives, emissions control efforts, waste management strategies, indoor environmental quality considerations, and innovations introduced.

In an exemplary embodiment, weights of the KPIs indicate importance of the associated KPI value to the overall health of the asset. These weight assignments offer a range of options, which could involve values spanning from 0 to 100. Higher values within this range signify a greater level of importance attributed to a particular KPI value in comparison to other KPIs for the asset. During the process of gauging the overall health of the service, the weight values corresponding to each KPI are utilized as multipliers. This application serves to standardize the KPIs, making them comparable even when they bear different weightings.

The reporting module 222 is configured to generate a report indicating the sustainability score of each building and the global sustainability score of the entity 102.

In an exemplary embodiment, the generated report is displayed on a centralized dashboard. This dashboard is equipped with multiple levels of hierarchy, which can be selected as per user preference. The higher levels of the dashboard exhibit Key Performance Indicators (KPIs), with these KPIs serving as an amalgamation of various individual KPIs. Additionally, the dashboard offers a visual representation of the assets associated with the building.

The centralized dashboard is also configured to display sustainability insights and corrective action recommendations. These insights and recommendations can originate from different levels within the structure of the entity 102, including the ground level, building level, and a broader organization-wide perspective.

In an embodiment the system 200 further comprises an insight deriving module configured to derive insights and provide corrective action recommendations. The insight deriving module leverages one or more machine learning (ML) models to derive the insights.

The one or more ML learning models may belong to at least one of supervised ML, unsupervised ML, and reinforced ML. Supervised machine learning comprises providing the machine with training data and the correct output value of the data. During supervised learning the values for the output are provided along with the training data (labeled dataset) for the model building process. The algorithm, through trial and error, deciphers the patterns that exist between the input training data and the known output values to create a model that can reproduce the same underlying rules with new data. Examples of supervised learning algorithms include regression analysis, decision trees, k-nearest neighbors, neural networks, and support vector machines.

If unsupervised learning is used, not all of the variables and data patterns are labeled, forcing the machine to discover hidden patterns and create labels on its own through the use of unsupervised learning algorithms. Unsupervised learning has the advantage of discovering patterns in the data with no need for labeled datasets. Examples of algorithms used in unsupervised machine learning include k-means clustering, association analysis, and descending clustering.

Whereas supervised and unsupervised methods learn from a dataset, reinforced learning (RL) methods learn from feedback to re-learn/retrain the models. Algorithms are used to train the predictive model through interacting with the environment using measurable performance criteria.

The audit generation module 224 is configured to generate audit reports in real-time based on selected compliance standard(s). These audit reports cater to a range of scenarios, including an audit report for a single building, or alternatively, buildings grouped under a specific geographical region (such as a city, state, or country). Additionally, the audit generation module 224 offers the capability to swiftly generate a Global Organization Report with a single click.

In some exemplary embodiments, the audit generation module 224 may generate intelligent audit reports pertaining to energy, water, waste, and emissions.

The intelligent energy audit report includes a record of energy consumption, along with savings objectives and an audited baseline for energy consumption related to buildings and organizations. The real-time monitoring of energy consumption and savings is maintained in comparison to the baseline and target. Additionally, the report provides forecasts for energy consumption and future demands. The report identifies and presents recommended measures to enhance the performance of specific zones, blocks, or load segments (such as chiller or lighting). These recommendations are grounded in a root cause analysis model, and they offer optimization techniques that are integrated into the system.

Similarly, the intelligent water audit report captures water consumption, savings objectives, and an audited baseline for water consumption of buildings and organizations. The real-time tracking of water consumption and savings is ongoing against the baseline and target. The report further extends to forecasting water consumption and future demands. Just as in the energy audit report, this report identifies areas for improvement, such as specific consumers or inefficient fittings, and offers optimization techniques and measures grounded in a root cause analysis model. Moreover, it also monitors, tracks, and predicts aspects like water recycling, rainwater harvesting and storage, and effluent management.

The intelligent emissions audit report includes a record related to emissions as well as decarbonization objectives and an audited baseline reports of buildings and organizations. The real-time Scope 1, Scope 2, Scope 3 emissions and offsets is continuously tracked with the baseline and target and forecast of emissions is also estimated. The report incorporates Machine Learning (ML) models to conduct a root cause analysis of challenging areas. Based on these analyses, the report offers optimization techniques and measures that are built into the system.

Intelligent Waste Audit report records waste generation of buildings and organizations coupled with objectives related to reduction, recycling, and reusing. The audited baseline for waste generation is also documented. This report continuously tracks real-time waste generation and recycling against the baseline and target. Future waste generation and recycling capacity forecasts are included as well. Much like the other audit reports, this one identifies areas for enhancement, such as specific waste categories (e-waste, organic, inorganic, paper waste, etc.), and recommends optimization techniques and measures grounded in root cause analysis models. Moreover, the report monitors, tracks, and predicts waste generated and recycled across all categories.

The forecast module 226 is configured to forecast sustainability score of each building and global sustainability score of the entity 102.

The forecast module 226 forecasts the sustainability score by utilizing the one or more ML models that are trained on data such as, but not limited to, sustainability score pattern, historical trends of energy consumption and savings, water consumption and savings, emissions, waste generation and recycled, indoor environment quality, building design, and operational efficiency.

The forecast module 226, by forecasting the sustainability score of each building and global sustainability score of the entity 102, offers several benefits such as, for example, performance improvement, cost savings, environmental impact, ensuring compliance with standards, enabling marketability, mitigating risk, long-term planning and budgeting, awareness towards changing compliance standards, making buildings more resilient in the face of resource scarcity or environmental reputation.

In some non-limiting embodiments, the forecast module 226 utilizes forecast models or predictive models which comprise mathematical or statistical tools used to make predictions about future sustainability scores. Some known types of forecast models can be such as, for example, time series models, regression models, econometric models, simulation models, Markov models, extrapolation models, and hybrid models.

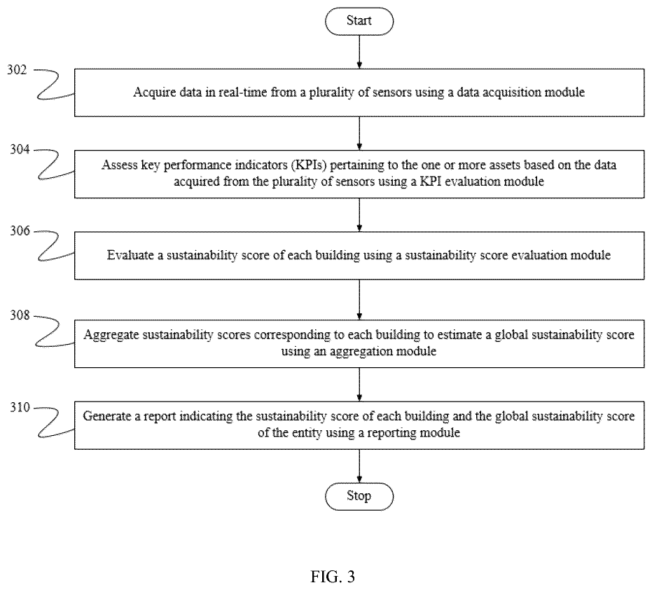

FIG. 3 is a flow chart 300 illustrating a method for calculating the sustainability score of the entity 102 in accordance with an embodiment of the invention.

At step 302, data is acquired in real-time from a plurality of sensors and one or more external sources using the data acquisition module 214, wherein the acquiring comprises monitoring, by the plurality of sensors, data pertaining to one or more assets associated with each building of the at least one building; data from multiple other data sources.

The plurality of sensors associated with the assets can be such as, but not limited to, timing sensors, location sensors, biometric sensors, environmental variable sensors, humidity sensors, device state sensors, temperature sensors, RH sensors, pressure sensors, flow sensors, power sensors, occupancy sensors, CO2 sensors, and indoor and outdoor Air Quality (IAQ) sensors.

The one or more external sources can be at least one of manual logs, utility bills, government compliances, regulatory policies, government policies, health and safety compliances, meteorological data, air quality data, weather data, any other related applications.

In an embodiment, each building of the one or more buildings at one or more geographical locations is connected to an edge platform. The edge platform is configured to integrate with the one or more sensors of the assets to analyze and process the received data in real-time. The edge platform outlined in this invention incorporates multiple edge devices that collectively execute various tasks, including but not limited to data transmission, routing, monitoring, filtering, translation, and storage. These functions are pivotal for the smooth passage of data across networks.

Employment of the edge computing effectively moves some portion of storage and computing resources out of the central data center and closer to the source of the data itself. Rather than transmitting raw data to a central data center for processing and analysis, that work is instead performed where the data is actually generated whether that is an enterprise data, industrial data, a retail store data, factory floor data, a sprawling utility or data across a smart city. Only the result of that computing work at the edge, such as real-time business insights, equipment maintenance predictions or other actionable answers, is sent back to the main data center for review and other human interactions.

At step 304, key performance indicators (KPIs) pertaining to the one or more assets are assessed based on the data acquired from the plurality of sensors using the KPI evaluation module 216.

In some non-limiting embodiments, the KPIs comprise an waste water plant performance indicator, UPS performance indicator, generator performance indicator, security system performance indicator, transformer performance indicator, air conditioner performance indicator, water resource performance indicator, chiller system performance indicator, emission system performance indicator, solar system performance indicator, heating system performance indicator, ventilation performance indicator, HVAC performance indicator, air handler performance indicator, water treatment plant performance indicator, smart bins performance indicator, fire hydrant system performance indicator, and exhaust system performance indicator.

At step 306, a sustainability score of each building is evaluated using the sustainability score evaluation module 218, wherein evaluating comprises comparing KPIs pertaining to the one or more assets against a selected compliance standard and organization goals and set targets.

In an embodiment, the compliance standard can be selected form at least one of, IGBC (Indian Green Building Council), ECBC (Energy Conservation Building Code under Bureau of Energy Efficiency), USGBC (United States Green Building Council), BREAM (Building Research Establishment Environmental Assessment Methodology), SGBC (Singapore Green Building Council), and BRSR (Business Responsibility and Sustainability Reporting).

At step 308, sustainability scores corresponding to each building are aggregated to estimate a global sustainability score using the aggregation module 220, wherein the global sustainability score is estimated in real-time based on one or more weights assigned to the KPIs pertaining to the one or more assets of each building.

The sustainability scores corresponding to each building are aggregated using one or more data aggregation algorithms. The data aggregation algorithms, when employed, derives values of KPIs of each asset of the plurality of assets and calculates the value of aggregate KPI using a weighted average of values for the plurality of KPIs associated with the plurality of assets.

In an embodiment the one or more weights assigned to the KPIs pertaining to the one or more assets of each building is based on building design efficiency, Site Planning, Water Conservation, Energy Efficiency, Emissions, Waste Management, Indoor Environmental Quality, and Innovations.

In an exemplary embodiment, weights of the KPIs indicate importance of the associated KPI value to the overall health of the asset. These weight assignments offer a range of options, which could involve values spanning from 1 to 10. Higher values within this range signify a greater level of importance attributed to a particular KPI value in comparison to other KPIs for the asset. During the process of gauging the overall health of the service, the weight values corresponding to each KPI are utilized as multipliers. This application serves to standardize the KPIs, making them comparable even when they bear different weightings.

At step 310, a report indicating the sustainability score of each building and the global sustainability score of the entity 102 is generated using the reporting module 222.

In an exemplary embodiment, the generated report is displayed on a centralized dashboard. This dashboard is equipped with multiple levels of hierarchy, which can be selected as per user preference. The higher levels of the dashboard exhibit Key Performance Indicators (KPIs), with these KPIs serving as an amalgamation of various individual KPIs. Additionally, the dashboard offers a visual representation of the assets associated with the building.

The centralized dashboard is also configured to display sustainability insights and corrective action recommendations. These insights and recommendations can originate from different levels within the structure of the entity 102, including the ground level, building level, and a broader organization-wide perspective.

At step 312, the audit generation module 224 generates audit reports in real-time based on selected compliance standard(s) for single building, or buildings grouped under a particular region or Global Organization Report in a single click.

At step 314, the sustainability score of each building and global sustainability score of the entity 102 are forecasted using the forecast module 226. The forecast module 226 forecasts the sustainability score by utilizing the one or more ML models that are trained on data such as, but not limited to, sustainability score pattern, historical trends of energy consumption and savings, water consumption and savings, emissions, waste generation and recycled, indoor environment quality, building design, and operational efficiency.

The present invention offers significant advantages by introducing a centralized monitoring system that standardizes the multi-variate sustainability parameters of a building through a unified Sustainability Score method. This system efficiently monitors, tracks, and manages the combined intelligence of multiple facilities' sustainability metrics across geographical locations, aligning them with global sustainability goals and benchmarks set by organizations.

More advantageously, the invention presents a structured framework that enables smart and secure connectivity between multiple sensors, buildings, and a central system. This central system empowers facility ground teams with operational control and provides leadership with data-driven business intelligence for actionable insights. It aggregates functional and operational data within a single system, facilitating enhanced building performance, energy goal management, and the achievement of sustainability targets. The system also acts as a reliable source of truth for audits, including ISOs, Greenmark, HSS, BRSR, and other relevant certifications. It contributes to the global initiative for climate change by ensuring compliance with international building codes, focusing on sustainable energy, water resource management, and emissions reduction.

In addition, the present invention introduces a ‘Sensor to Sustainability Insights’ approach, utilizing unique and comprehensive business rules that integrate data from various building systems, structures, and enterprise systems. This integration generates a comprehensive Sustainability Suite with a corresponding Sustainability score.

The present invention also provides a solution to achieve a fully autonomous, transformed, and sustainable smart building state. It acts as a digital twin of the built environment by harmonizing data from previously distinct devices and business systems, offering a centralized perspective. This enhanced ecosystem agility enables real-time responses to dynamic changes.

The invention optimizes HVAC, lighting, and more systems through AI-ML powered smart maintenance, ensuring reliability and stable operations. Leveraging global insights, the invention empowers organizational leaders with sustainability scores, ESG reporting, energy efficiency metrics, cost savings analyses, current trends, and future forecasts for multiple buildings across various geographical areas. It helps improve productivity in workspaces with better indoor environmental quality and dynamic management of occupants' needs, ensuring the right balance with data privacy. Furthermore, it facilitates compliance with standards such as BRSR, HSS, ISO, and local building code, promoting de-carbonization, water positivity and environmental-friendly practices aligned with sustainable development goals.

Those skilled in the art will realize that the above-recognized advantages and other advantages described herein are merely exemplary and are not meant to be a complete rendering of all of the advantages of the various embodiments of the present invention.

In the foregoing complete specification, specific embodiments of the present invention have been described. However, one of ordinary skill in the art appreciates that various modifications and changes can be made without departing from the scope of the present invention. Accordingly, the specification and figures are to be regarded in an illustrative rather than a restrictive sense. All such modifications are intended to be included within the scope of the present invention.

We claim:

1. A system 200 for calculating real-time sustainability score of an entity 102, the entity 102 having at least one building in at least one geographical location, the system 200 comprising:
a memory 202 configured to store one or more executable components; and
a processor 204 operatively coupled to the memory 202, the processor 204 configured to execute the one or more executable components, the one or more executable components comprising:
a data acquisition module 214 configured to acquire data in real-time from a plurality of sensors and one or more external sources, wherein the plurality of sensors is configured to monitor data pertaining to one or more assets associated with each building of the at least one building;
a KPI evaluation module 216 configured to assess key performance indicators (KPIs) pertaining to the one or more assets based on the data acquired from the plurality of sensors and the one or more external sources;
a sustainability score evaluation module 218 configured to evaluate a sustainability score of each building, wherein the sustainability score evaluation module is configured to compare KPIs pertaining to the one or more assets against at least one of a compliance standard, organization energy goals, water goals, emission goals, waste goals, and digital transformation scale;
an aggregation module 220 configured to aggregate the sustainability scores corresponding to each building to estimate a global sustainability score, wherein the global sustainability score is estimated in real-time based on one or more weights assigned to the KPIs pertaining to the one or more assets of each building; and
a reporting module 222 configured to generate a report indicating the sustainability score of each building, global sustainability score of the entity 102.

2. The system 200 of claim 1, wherein the entity 102 is related to a plurality of categories such as, the plurality of categories comprising at least one of a commercial category an industrial category, a residential category, and a retail-mixed developments category.

3. The system 200 of claim 1, wherein the one or more assets comprise at least one waste treatment plants, Uninterrupted Power Supply (UPS), generators, security systems, transformers, air conditioners, water resources, chiller systems, emission systems, roof top solar systems, Heating, ventilation, and Air Conditioning (HVAC), and exhaust systems.

4. The system 200 of claim 1, wherein the plurality of sensors comprises at least one of temperature sensors, relative humidity (RH) sensors, pressure sensors, flow sensors, power sensors, occupancy sensors, motion sensors, water quality sensors, gas sensors, plant growth sensors, internal air quality sensors, and external air quality sensors.

5. The system 200 of claim 1, wherein the one or more external sources can be at least one of manual logs, utility bills, government compliances, regulatory policies, government policies, health and safety compliances, meteorological data, air quality data, weather data, any other related applications.

6. The system 200 of claim 1, wherein the KPIs are assessed based on one or more sustainability factors, the one or more sustainability factors comprising at least one of building performance index (BPI), energy efficiency index (EEI), energy savings, carbon footprint, green power quotient-onsite offsite renewables, water balance-consumption and recycled, waste management and reduce-reuse-recycle practices, air quality, water quality, emission and effluent control, and organization Corporate Socio Responsibility (CSR) plantations health and respective carbon sequestration.

7. The system 200 of claim 1, wherein a compliance standard is selected from one of IGBC (Indian Green Building Council), ECBC (Energy Conservation Building Code under Bureau of Energy Efficiency), USGBC (United States Green Building Council), BREAM (Building Research Establishment Environmental Assessment Methodology), SGBC (Singapore Green Building Council), and BRSR (Business Responsibility and Sustainability Reporting).

8. The system 200 of claim 1, wherein the weights assigned to the KPIs pertaining to the one or more assets of each building is based on building design efficiency, Site Planning, Water Conservation, Energy Efficiency, Emissions, Waste Management, Indoor Environmental Quality, and Innovations.

9. The system 200 of claim 1 comprising an insights module configured to derive insights and provide corrective action recommendations, wherein the insights module leverages one or more machine learning (ML) models to derive the insights and optimize the operations.

10. The system 200 of claim 1, wherein the reporting module 222 further comprises a centralized dashboard configured to display sustainability insights and corrective action recommendations from at least one of a ground level of the entity 102, a building level of the entity 102, and a holistic organization level.

11. The system 200 of claim 1 further comprises an audit generation module 224 configured to generate audit reports in real-time based on selected compliance standard(s) for single building, or buildings grouped under a particular region (City, State, Country) or Global Organization Report in a single click.

12. The system 200 of claim 1 further comprises a forecast module 226 configured to forecast sustainability score of each building and global sustainability score of the entity 102, wherein the forecast module 226 forecasts sustainability score by utilizing the one or more machine learning (ML) models that are trained on sustainability score pattern, historical trends of energy consumption and savings, water consumption and savings, emissions, waste generation and recycled, indoor environment quality, building design, and operational efficiency.

13. A method for calculating real-time sustainability score of an entity 102, the entity 102 having at least one building in at least one geographical location, the method comprising:
acquiring data in real-time from a plurality of sensors and one or more external sources using a data acquisition module 214, wherein the acquiring comprises monitoring, by the plurality of sensors, data pertaining to one or more assets associated with each building of the at least one building;
assessing key performance indicators (KPIs) pertaining to the one or more assets based on the data acquired from the plurality of sensors and the one or more external sources using a KPI evaluation module 216;
evaluating a sustainability score of each building using a sustainability score evaluation module 218, wherein the sustainability score evaluation module 218 is configured to compare KPIs pertaining to the one or more assets against at least one of a compliance standard, organization energy goals, water goals, emission goals, waste goals, and digital transformation scale;
aggregating the sustainability score corresponding to each building to estimate a global sustainability score using an aggregation module 220, wherein the global sustainability score is estimated in real-time based on one or more weights assigned to the KPIs pertaining to the one or more assets of each building;
generating a report indicating the sustainability score of each building, global sustainability score of the entity 102 using the reporting module 222.

14. The method of claim 13, wherein an entity 102 is related to a plurality of categories, the plurality of categories comprising at least one of a commercial category, an industrial category, a residential category, and a retail-mixed developments category.

15. The method of claim 13, wherein the one or more assets comprise at least one of waste treatment plants, Uninterrupted Power Supply (UPS), generators, security systems, transformers, air conditioners, water resources, chiller systems, emission systems, roof top solar systems, Heating, ventilation, and Air Conditioning (HVAC), and exhaust systems.

16. The method of claim 13, wherein the plurality of sensors is at least one of temperature sensors, relative humidity (RH) sensors, pressure sensors, flow sensors, power sensors, occupancy sensors, motion sensors, water quality sensors, gas sensors, plant growth sensors, internal air quality sensors, and external air quality sensors.

17. The method of claim 13, wherein the one or more external sources can be at least one of manual logs, utility bills, government compliances, regulatory policies, government policies, health and safety compliances, meteorological data, air quality data, weather data, any other related applications.

18. The method of claim 13, wherein the KPIs are assessed based on one or more sustainability factors, the one or more sustainability factors comprising at least one of building performance index (BPI), energy efficiency index (EEI), energy savings, carbon footprint, green power quotient-onsite offsite renewables, water balance-consumption and recycled, waste management and reduce-reuse-recycle practices, air quality, water quality, emission and effluent control, and organization Corporate Socio Responsibility (CSR) plantations health and respective carbon sequestration.

19. The method of claim 13, wherein the selected compliance standard is selected from one of IGBC (Indian Green Building Council), ECBC (Energy Conservation Building Code under Bureau of Energy Efficiency), USGBC (United States Green Building Council), BREAM (Building Research Establishment Environmental Assessment Methodology), SGBC (Singapore Green Building Council), and BRSR (Business Responsibility and Sustainability Reporting).

20. The method of claim 13, wherein the weights assigned to the KPIs pertaining to the one or more assets of each building is based on building design efficiency, Site Planning, Water Conservation, Energy Efficiency, Emissions, Waste Management, Indoor Environmental Quality, and Innovations.

21. The method of claim 13 further comprises deriving insights and providing corrective action recommendations using an insight deriving module, wherein the insight deriving module leverages one or more machine learning (ML) models to derive the insights and optimize the operations.

22. The method of claim 13 further comprises displaying sustainability insights and corrective action recommendations from at least one of a ground level of the entity 102, a building level of the entity 102, and a holistic organization level using a centralized dashboard of the reporting module 222.

23. The method of claim 13 further comprises generating audit reports in real-time based on selected compliance standard(s) for single building, or buildings grouped under a particular region (City, State, Country) or Global Organization Report in a single click using an audit generation module 224.

24. The method of claim 13 further comprises forecasting sustainability score of each building and global sustainability score of the entity 102 using a forecast module 226, wherein the forecast module 226 forecasts sustainability score by utilizing the one or more machine learning (ML) models that are trained on sustainability score pattern, historical trends of energy consumption and savings, water consumption and savings, emissions, waste generation and recycled, indoor environment quality, building design, and operational efficiency.
